(19) United States
(12) Patent Application Publication
(10) Pub. No.: US 2015/0169068 A1
(43) Pub. Date: Jun. 18, 2015

(54) Gestural Sorting of Content

(71) Applicant: Google Inc., Mountain View, CA (US)

(72) Inventors: Christian Plagemann, Menlo Park, CA (US); Hendrik Dahlkamp, Palo Alto, CA (US); Varun Ganapathi, San Francisco, CA (US); Adam Jonah Feldman, San Francisco, CA (US)

(21) Appl. No.: 13/771,495

(22) Filed: Feb. 20, 2013

(51) Int. Cl. G06F 3/01

(52) U.S. Cl. CPC G06F 3/017

(57) ABSTRACT

Content, such as an email inbox may be presented on a display. A three dimensional position of an object may be determined at two or more reference points. A movement of the object may be decoded based on the determined difference between the two or more reference points. The movement may correspond to a gesture. The decoded movement may be used to sort content. For example, content may be sorted to a function such as archive or to a folder.

### BACKGROUND

In a traditional computing system, a user may make selections using an input device such as a mouse or keyboard. Voice commands and gestures may be used in some configurations as well. For example, some game consoles track a user's movements and translate the movement into a predefined animation sequence on a TV screen. A traditional user interface presents a user with a series of menu options that are selectable using an input. Touch screen interfaces also may make use of a menu interface.

### BRIEF SUMMARY

According to an implementation of the disclosed subject matter, a first three dimensional position of an object may be determined. A second three dimensional position of the object may be determined. A movement may be decoded based on the difference between the first position and the second position. Based on the decoded, movement, content may be sorted.

In an implementation, a system is provided that includes a database and a processor. The database may store a three dimensional position of an object. The processor may be configured to determine a first and a second three dimensional position. The processor may decode a movement based on the difference between the first position and the second position. Based on the decoded movement, the processor may be configured to sort a content.

Additional features, advantages, and implementations of the disclosed subject matter may be set forth or apparent from consideration of the following detailed description, drawings, and claims. Moreover, it is to be understood that both the foregoing summary and the following detailed description provide examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows an example process flow according to an implementation disclosed herein.

FIG. 4A shows an example of an email inbox.

FIG. 4B shows an example of a first email.

FIG. 4C shows the email inbox with the first email sorted to the priority box and/or inbox.

FIG. 4D shows a second email.

FIG. 4E shows the email inbox with the first email sorted to the trash tab.

FIG. 4F shows a different gesture than that shown in FIG. 4B to sort the email.

FIG. 4G shows a different gesture than that shown in FIG. 4D to sort the spam email to a trash folder or tab.

### DETAILED DESCRIPTION

Implementations of the disclosed subject matter can provide one or more ways to sort content on a monitor using a gesture. In an implementation, a gesture may be detected. The gesture may instruct a device or application to associate selected content with a particular folder or function such as archive, delete, mark as a high priority, bookmark, or add to a schedule. For example, a user may access a web-based email program with an inbox that shows a number of messages chronologically ordered from the newest to the oldest email message. The user may gesture toward the screen in a right-to-left motion that causes the first message in the list to be moved into an archive list or bin. The first message may be removed from the inbox screen. The second message on the screen may move to the top of the inbox, possibly occupying the space vacated by the first message. The user may make a motion in a left-to-right direction which may cause the second message to be deleted from the user's inbox.

Variations in the direction of the gesture or the gesture detected may be used in some configurations. For example, the length of a gesture may be determined and used to distinguish a short gesture from a relatively long gesture in the same direction. A short gesture to the left may cause a song to be added to a first playlist and a long gesture to the left may be associated with a second playlist. The direction of movement need not be limited to left or right movement or even substantially linear movements.

A user's hand position may be associated with specific gestures. For example, when a single finger is held up and detected, it may signal to the system that the user would like to navigate the content on the page. If two fingers are detected, however, it may signal to the system that the user would like to access the sorting functions. Thus, the disclosure proposes several ways to efficiently sort content on a monitor with a touch-less interface.

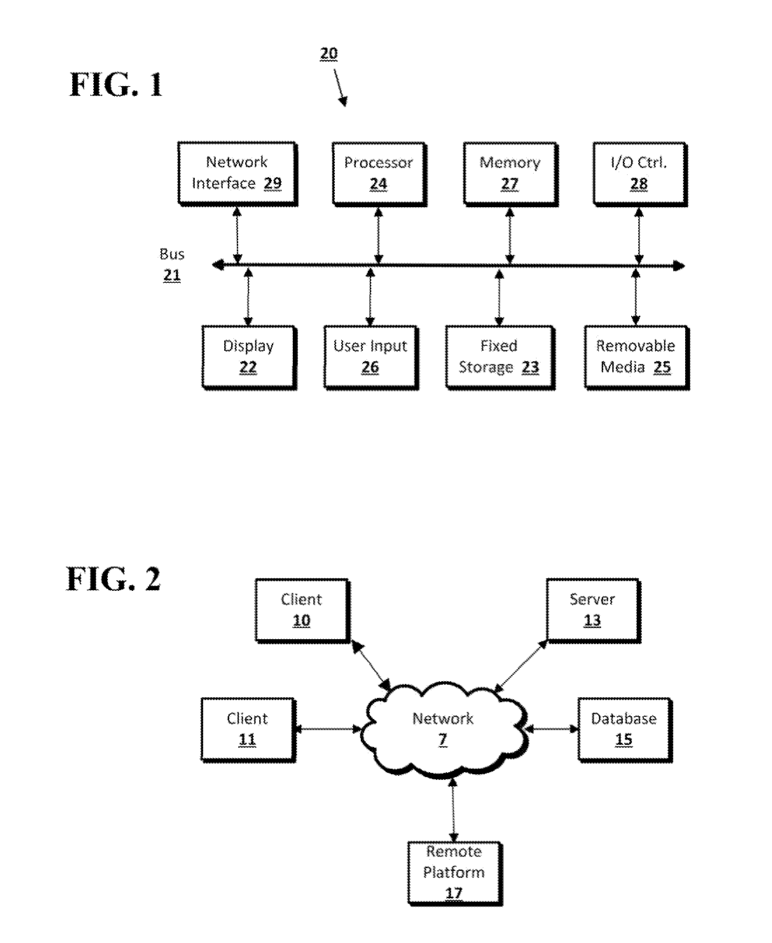

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

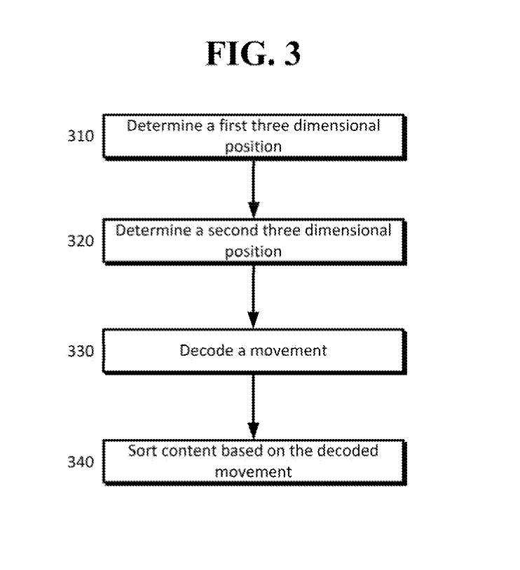

In an implementation, an example of which is provided in FIG. 3, a first three dimensional position of an object may be determined at 310. A three dimensional position may be determined by one or more cameras such as a depth or RGB camera. In some configurations, the object may communicate a three dimensional position, such as by GPS, to a processor that may be local or remote to the object. In the event that the object communicates a three dimensional position, the step of determining 310 may refer to receiving an indication of the three dimensional position of the object. It may refer to mapping, by a local or remote processor, to an environment or space or to a coordinate system. Examples of an object may include, for example: a wand, a remote, an appendage, a hand, a finger, or the like. In some instances, the object may refer to a combination of objects as used herein. A user may make a gesture using a distinct hand and finger (e.g., objects) position. For example, a user may extend a hand towards a monitor with the index finger up and the other fingers in a closed fist. A different action may be requested by a different gesture such as a hand extended orthogonal to the user with the palm facing the monitor. In some configurations, an orientation of an object may be determined. Different orientations of the same object may be associated with different actions. For example, different hand orientations may be determined based upon: an angle of the hand relative to the user's body, an angle of the hand relative to a reference, an orientation of the hand, and a position of one or more fingers. A second three dimensional position of the object may be determined at 320.

The three dimensional position of the object or an indication thereof may be received by a processor and/or stored to a computer readable medium. In some instances, the object may have a first processor associated with it that receives the three dimensional position. The object may communicate an indication of the three dimensional position using a communication protocol such as RFID, Ethernet, Bluetooth, near field communication, or the like. The communicated three dimensional position may be received by a second processor, possibly physically distinct from the processor that is local to the object. The second processor may communicate the three dimensional position to a remote server, database, cloud service, or the like.

The first three dimensional position and the second three dimensional position may be chronologically the first and second three dimensional position generated from the object or determined. Multiple three dimensional positions for an object may be stored to computer readable medium. Any two positions may be considered the first and second position, irrespective of the amount of time in between the receipt of an indication of each position or the determination thereof. For example, a depth camera may capture multiple images which may be analyzed to determine, for example, whether a user is present and/or whether a gesture is being made. The determination of a first three dimensional position may require, therefore, multiple images to be captured by a camera and the corresponding analysis. A second three dimensional position may also require a similar process.

Returning to FIG. 3, a movement may be decoded based on the difference between the first position and the second position at 330. Decoding a movement may refer to determining a gesture. For example, a first three dimensional position may correspond to a first-hand position of a gesture (e.g., a hand used to point at a monitor) and a second three dimensional position may correspond to a second hand position of the gesture (e.g., the hand moving from the first position laterally from right to left parallel to the ground). The decoded movement, therefore, may represent a first movement and a subsequent decoded movement, irrespective of whether it is chronologically or sequentially second to the first movement, may represent a second movement.

Based on the decoded movement, content may be sorted at 340. For example, based on a first movement, content may be deleted or saved. Likewise, a second movement may be deleted or saved. Content may refer to, for example: a plurality of electronic messages, a plurality of videos, a plurality of songs, a plurality of electronic, a plurality of electronic mail, a plurality of addresses, and a plurality of phone numbers. Sorting may refer to an association of a particular content with a folder, file path, category, priority, order or function (e.g., save, delete, archive). For example, songs may be sorted into music genre categories, phone numbers may be sorted by friends, family, or business, and email may be sorted into different priority bins or folders. Sorting may refer to a physical movement of content. For example, if content is associated with a friend group, it may be stored on a first hard drive while if the content were associated with a business group, the content may be associated with a second hard drive.

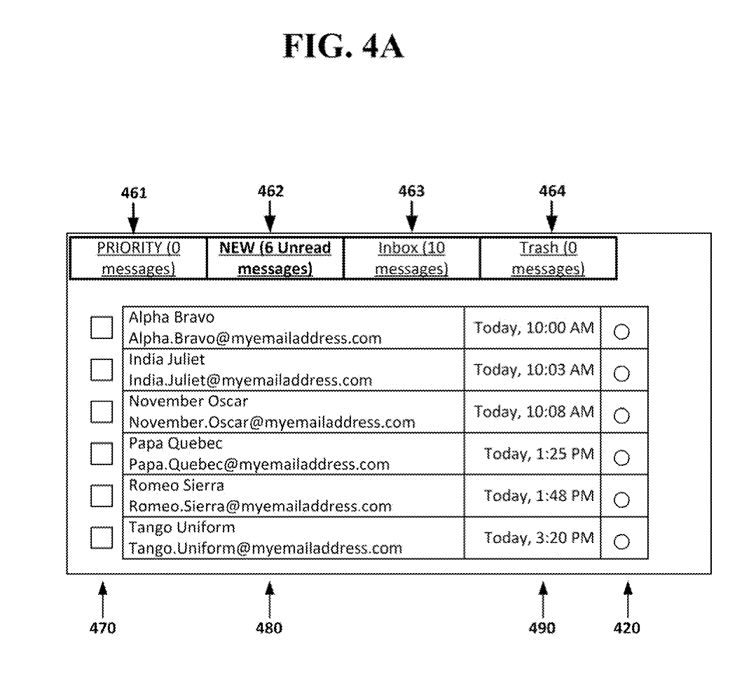

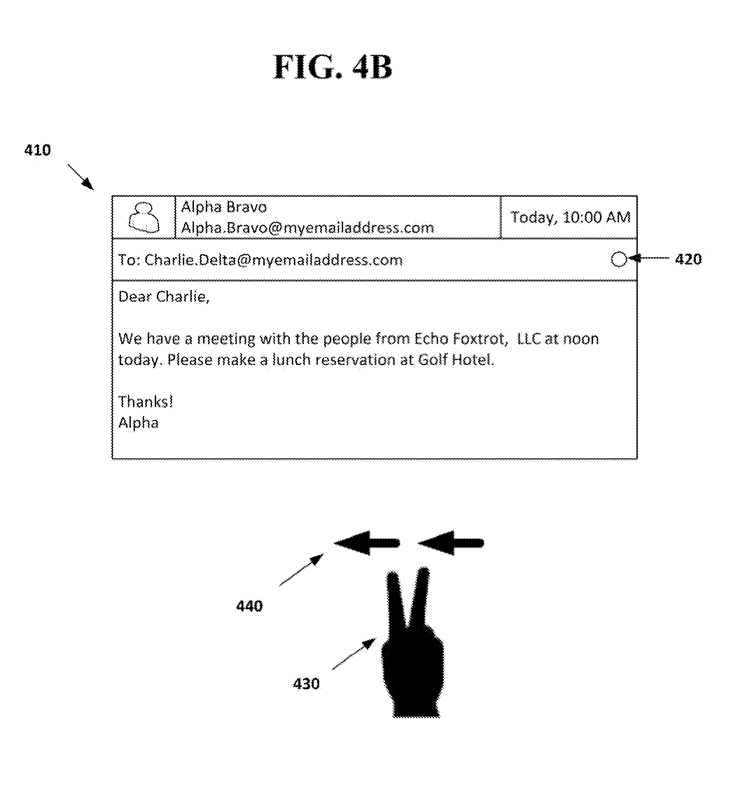

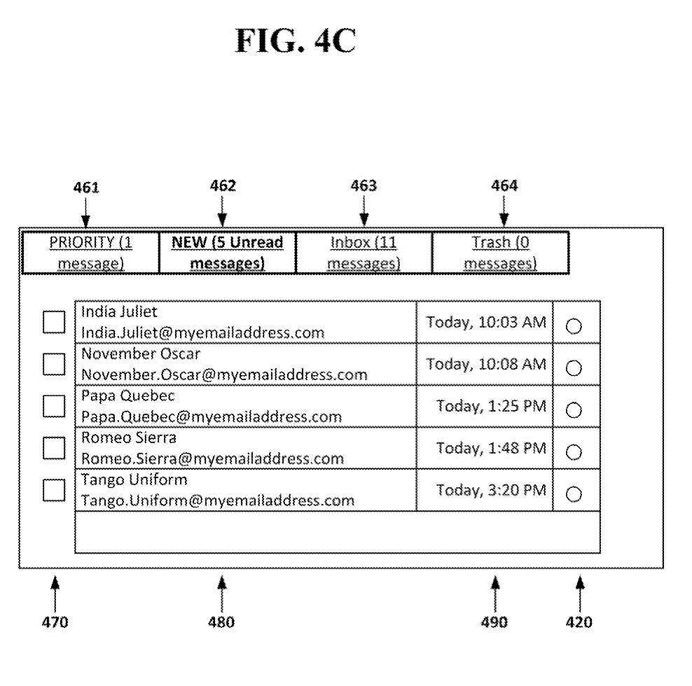

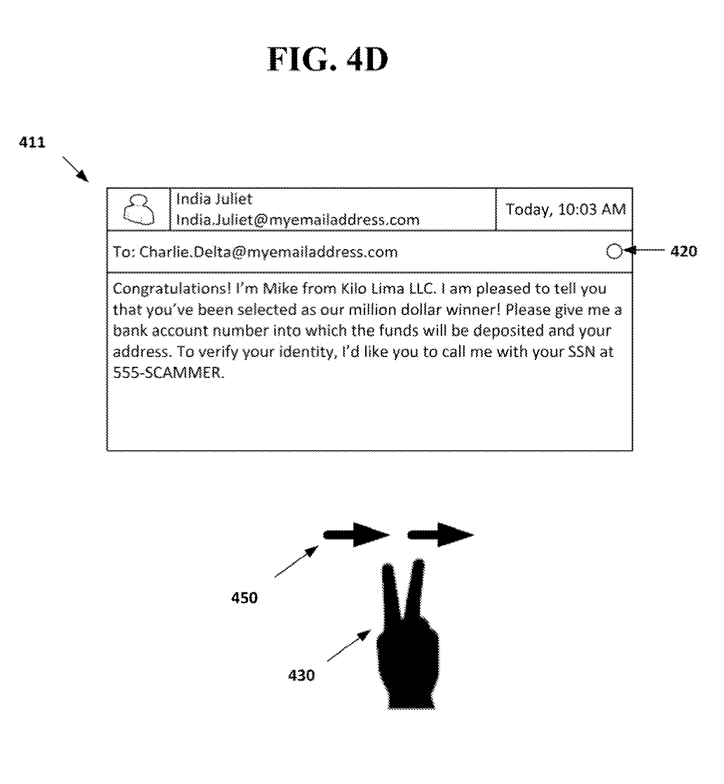

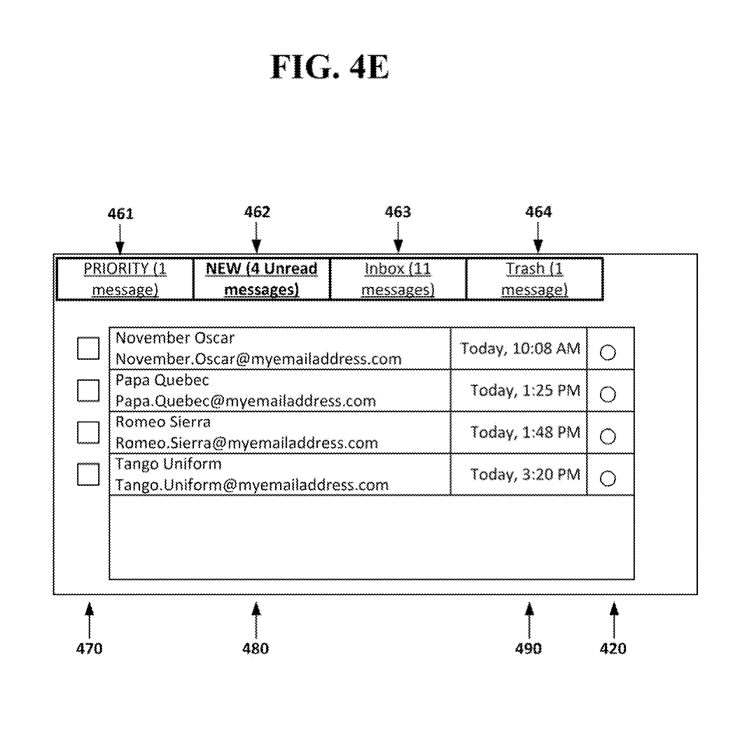

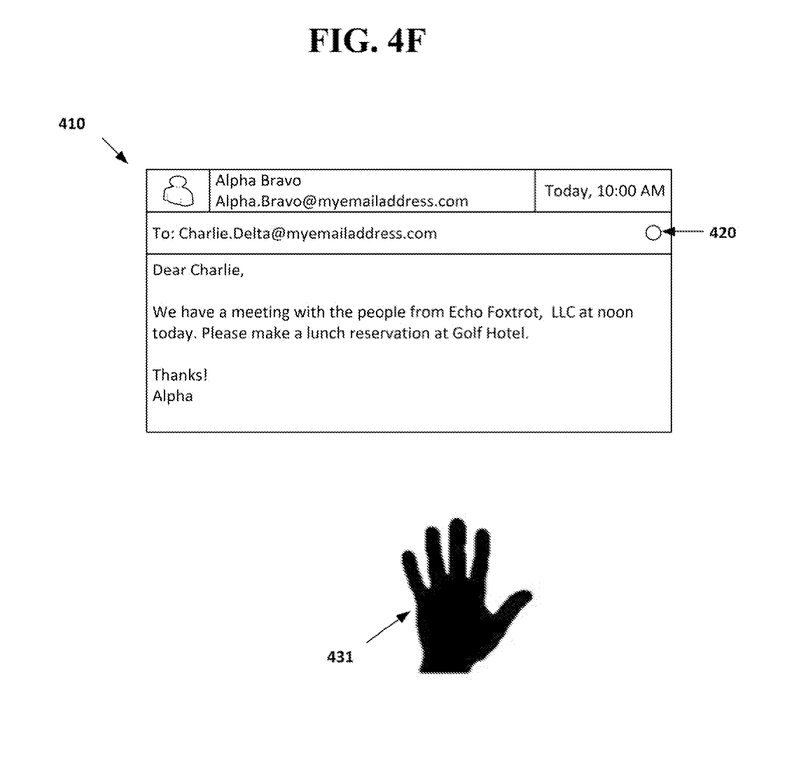

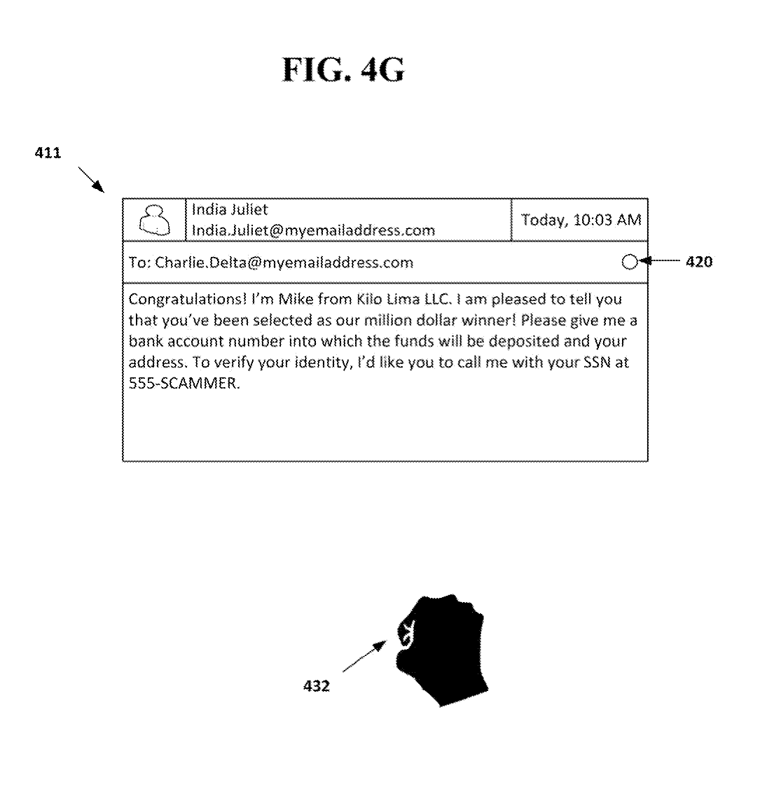

An example of an implementation is provided in FIGS. 4A-G. FIG. 4A shows an example of a window of an email service or software shown on a display. The window shown 460 contains four tabs at the top representing priority items 461, new items 462, an inbox 463, and deleted or trash items 464. Each tab indicates the number of items associated with it; for example, the new items tab 462 indicates that there are six unread messages. The window shown in FIGS. 4A, C, and E is the new messages tab 462. This window shows a selectable box 470, email identity 480, date of receipt 490, and a marker 420. The selectable box, for example, may be interacted with by a conventional method such as a keyboard, mouse, and/or touch interaction. Similarly, the marker may receive interaction using a conventional method. It may provide an indication of priority or identity of the sender. It may be shaded, colored, or have a different appearance to communicate information about the message or sender to the owner of the email account to which the email has been sent. It may be derived from the sender or the recipient.

According to an implementation, the user of the email account may view the new messages tab 462 as a default upon logging into the account. The user may systematically progress through the messages beginning with the first message from Alpha Bravo or select a particular message using a gesture or a keyboard, mouse, and/or touch interaction. In FIG. 4B, an email message 410 from Alpha Bravo is shown. The user may make a gesture with a hand 430 that is a right-to-left action 440 to indicate that the email should be a high priority item. The user's gesture may cause the marker 420 to be changed to indicate a priority. The email may be associated with the high priority tab 461 and the inbox 463. Although the gesture indicated in FIG. 4B is a hand swipe with two fingers, any gesture may be similarly associated with the function of sorting the message as described. For example, a closed first swiped right-to-left may cause the email to be sent to a printer or print server.

After receiving the user's gesture and sorting the email according to the gesture received, the email from Alpha Bravo may be removed from the new messages queue as shown in FIG. 4C. The message from Alpha Bravo was sorted into or associated with the priority bin 461 which now shows one message being present in that tab. The message, a copy of the message, or an association of the message, also may be displayed in the inbox tab 463. The other messages in the queue 480 may move up or occupy the space once held by Alpha Bravo's message.

An indication that the user would like to view the email from India Juliet may be received and that email 411 may be shown as in FIG. 4D. This email 411 is a spam message that the user may wish to quickly dispose of. The user may make a gesture that is represented by the arrows as a left-to-right action 450. The gesture may be received and determined to be associated with the function of deleting the email. FIG. 4E shows the new messages tab 462 and shows that the email message from India Juliet has been sent to the trash 464. The other remaining email messages 480 have moved up in the queue.

The tabs shown in FIGS. 4A-G may correspond, for example, to a folder that is stored on a computer readable medium. The folder may be interacted with using any variety of methods including gestures. The gestures 440, 450 received from the user may be decoded to indicate a movement and send the content to a destination. The first gesture 440 may be associated with a particular group (e.g., priority items) and the second gesture 450 may be associated with a second group (e.g., trash).

FIGS. 4F-G show gestures that are different from those shown in FIGS. 4B and 4D respectively. For example, in FIG. 4F, the gesture 431 is represented by a hand facing a monitor containing the email software. The gesture may be determined to cause the email message to be sorted into the priority tab. Similarly, the gesture 432 shown in FIG. 4G, a closed fist, may cause the email to be sent to the trash tab/folder or to be deleted. In some configurations, a user may determine the function ascribed to a particular gesture or which gesture is ascribed to a function. Thus, implementations disclosed herein are not limited to a particular gesture being associated with a function or sorting method.

In an implementation, a system is provided that includes a database and a processor connected to the database. The processor may be remote from the database and connected to it via the Internet or a wireless protocol, for example. The database may store one or more three dimensional positions of an object. The processor may determine a first three dimensional position of an object. The three dimensional position may be determined based on data received and processed by a camera, for example. The processor may receive an indication of the three dimensional position of the object from a processor associated with the camera. Similarly, a second three dimensional position, or indication thereof, may be received by the processor. A movement may be decoded based on the difference between the first position and second position. In some configurations it may be desirable to have the three dimensional positions associated with a particular object and a particular function. For example, a hand gesture such as a right-to-left swipe may be associated with a sorting function such as delete, save, prioritize, mark, archive, bookmark, etc. Based on the decoded movement, content may be sorted.

In some instances, the distance between a first three dimensional position and a second three dimensional position of a portion of the object may be minimal or zero. For example, if the object is a user's hand and the user holds a palm toward the screen, this may be a first gesture. The user may rotate the hand 180 degrees on a vertical axis such that the back of the hand faces the screen to form the second gesture. The distance between the first three dimensional position, that may be associated with the first gesture, and the second three dimensional position, which may be associated with the second gesture is essentially zero if the middle finger is the only point of reference. However, the distance between the thumb in the first gesture and the second gesture may be detectable. Thus, in some configurations, multiple points of reference for an object may be used to determine the distance between the first three dimensional position and the second three dimensional position. In some instances, a mean, a sum, a median, or other metric of analysis may be utilized according to implementations disclosed herein. The three dimensional position received may be based on a mean, median, etc.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method, comprising:
presenting multiple em messages to a user;
obtaining multiple images that are generated while or immediately after presenting the multiple email messages to the user;
determining that the images show the user performing a gesture that involves the user moving their hands;
selecting, based at least on the gesture, a particular one of the multiple email messages;
determining, from among multiple different commands that are associated with filing email messages, a particular email message filing command; and
applying the particular email message filing command to the particular one of the multiple email messages.

2-26. (canceled)

27. The computer-implemented method of claim 1, comprising:
after filing the particular email message, removing the particular email message from among the multiple email messages that are presented to the user.

28. The computer-implemented method of claim 1, wherein:
the particular email filing command comprises an archive command; and
applying the particular email command to the particular one of the multiple email messages, comprises archiving the particular one of the multiple email messages.

29. The computer-implemented method of claim 1, wherein:
the particular email filing command comprises a bookmark command; and
applying the particular email command to the particular one of the multiple email messages, comprises bookmarking the particular one of the multiple email messages.

30. The computer-implemented method of claim 1, wherein:
the particular email filing command comprises a prioritization command; and
applying the particular email command to the particular one of the multiple email messages, comprises associating the particular one of the multiple email messages with a high priority with respect to other email messages.

31. The computer-implemented method of claim 1, wherein:
the particular email filing command comprises a print command; and
applying the particular email command to the particular one of the multiple email messages, comprises transmitting the particular one of the multiple email messages to a printer.

32. A non-transitory computer-readable storage device having instructions stored thereon that, when executed by a computing device, cause the computing device to perform operations comprising:
presenting multiple email messages to a user;
obtaining multiple images that are generated while or immediately after presenting the multiple email messages to the user;
determining that the images show the user performing a gesture that involves the user moving their hands;
selecting, based at least on the gesture, a particular one of the multiple email messages;
determining, from among multiple different commands that are associated with filing email messages, a particular email message filing command; and
applying the particular email message filing command to the particular one of the multiple email messages.

33. The storage device of claim 32, wherein the operations further comprise:
after filing the particular email message, updating the presentation of multiple email messages to omit the particular email message.

34. The storage device of claim 32, wherein:
the particular email filing command comprises an archive command; and
applying the particular email command to the particular one of the multiple email messages, comprises archiving the particular one of the multiple email messages.

35. The storage device of claim 32, wherein:
the particular email filing command comprises a bookmark command; and
applying the particular email command to the particular one of the multiple email messages, comprises bookmarking the particular one of the multiple email messages.

36. The storage device of claim 32, wherein:
the particular email filing command comprises a prioritization command; and
applying the particular email command to the particular one of the multiple email messages, comprises associating the particular one of the multiple email messages with a high priority with respect to other email messages.

37. The storage device of claim 32, wherein:
the particular email filing command comprises a print command; and
applying the particular email command to the particular one of the multiple email messages, comprises transmitting the particular one of the multiple email messages to a printer.

38. A system comprising:
one or more data processing apparatus; and
a computer-readable storage device having stored thereon instructions that, when executed by the one or more data processing apparatus, cause the one or more data processing apparatus to perform operations comprising:
presenting multiple email messages to a user;
obtaining multiple images that are generated while or immediately after presenting the multiple email messages to the user;
determining that the images show the user performing a gesture that involves the user moving their hands;
selecting, based at least on the gesture, a particular one of the multiple email messages;
determining, from among multiple different commands that are associated with filing email messages, a particular email message filing command; and
applying the particular email message filing command to the particular one of the multiple email messages.

39. The system of claim 38, wherein the operations further comprise:
after filing the particular email message, updating the presentation of multiple email messages to omit the particular email message.

40. The system of claim 38, wherein:
the particular email filing command comprises an archive command; and
applying the particular email command to the particular one of the multiple email messages, comprises archiving the particular one of the multiple email messages.

41. The system of claim 38, wherein:
the particular email filing command comprises a bookmark command; and
applying the particular email command to the particular one of the multiple email messages, comprises bookmarking the particular one of the multiple email messages.

42. The system of claim 38, wherein:
the particular email filing command comprises a prioritization command; and
applying the particular email command to the particular one of the multiple email messages, comprises associating the particular one of the multiple email messages with a high priority with respect to other email messages.

43. The system of claim 38, wherein:
the particular email filing command comprises a print command; and
applying the particular email command to the particular one of the multiple email messages, comprises transmitting the particular one of the multiple email messages to a printer.
